(19) United States
(12) Patent Application Publication
(10) Pub. No.: US 2014/0201022 A1
(43) Pub. Date: Jul. 17, 2014

(54) VEHICLE DAMAGE PROCESSING AND INFORMATION SYSTEM

(71) Applicant: Andre Balzer, Kienberg (CH)

(72) Inventor: Andre Balzer, Kienberg (CH)

(21) Appl. No.: 14/157,472

(22) Filed: Jan. 16, 2014

Related U.S. Application Data
(60) Provisional application No. 61/895,301, filed on Oct. 24, 2013.

(30) Foreign Application Priority Data
Jan. 16, 2013 (CH) 0194/13

(51) Int. Cl. G06Q 30/06; G06T 7/00

(52) U.S. Cl. CPC G06Q 30/0611; G06T 7/0002
USPC 705/26.4

(57) ABSTRACT

A system that determines an estimate of damage to a surface area of a vehicle. The system may include a scanner that generates scanning data representative of a surface area of the vehicle. The system may also include a computing device that processes the scanning data to detect damage items and generates an estimate of damage using the processed scanning data.

### CROSS-REFERENCE TO RELATED APPLICATIONS

This application claims priority to U.S. Provisional Patent Application No. 61/895,301, filed Oct. 24, 2013, and Swiss Patent Non-Provisional Application No. 00194/13, filed Jan. 16, 2013.

### BACKGROUND OF THE INVENTION

1. Field of the Invention

The present invention relates to systems and methods for estimating vehicle damage.

2. Background

Typically, for car repair facilities, car insurance firms and damage appraisers, it is necessary to obtain an appraisal of the damage to a car (i.e. an automobile) resulting from a collision. It is particularly important to determine efficiently and accurately an estimate of the collision damage, including the time and/or cost for repairing the damage to the car.

US2006/0114531 describes a vehicle inspection station that uses several cameras to capture images of a car. For detecting whether a car has damage, at least a portion of an image is compared with a previously stored image of the vehicle. However, the vehicle inspection station is not configured to assess the damage and/or provide an estimate for the repair of the damage.

U.S. Pat. No. 5,839,112 describes a computerized insurance estimating system which can be used by automobile insurance appraisers and repair facilities to obtain information about parts, labor, and repair operations for automobile (car) repairs. An application program displays various sections of the outer layer of the vehicle including body parts of the car, such as the rear bumper, doors, rear and front fenders, and the hood of the vehicle, or windows, such as the rear window or the windshield. By clicking on provided selection circles, the user selects one or more damaged vehicle parts. The estimate is based on the selected vehicle parts and cost data defining for each part its purchase price and the cost of the labor involved in replacing the part. The system is not configured, however, to determine in more detail the damage to individual parts of the car.

US 2004/0073434 describes a method and a system for estimating automobile damage that can be fixed through paintless dent repair, i.e. techniques for removing dents from the body of a motor vehicle when the paint is not damaged. Several vehicle parts are displayed in a user interface, and for each vehicle part a number of dents can be specified by the user. In addition, the size of the dents can be specified by the user by selecting one or more of the illustrated dent sizes. The information about the damage is communicated to a central computer, which generates a report including the repair costs for the vehicle. The system makes it possible to determine different levels of damage on body parts of a car, however, damage definition is limited to circular dents and a small number of given sizes.

### BRIEF SUMMARY OF THE INVENTION

A system that determines an estimate of damage to a surface area of a vehicle. The system may include a scanner that generates scanning data representative of a surface area of the vehicle. The system may also include a computing device that processes the scanning data to detect damage items and generates an estimate of damage using the processed scanning data.

### BRIEF DESCRIPTION OF THE DRAWINGS

FIG. 1 is an illustration of a system with a computing device and a scanner that scans an object.

FIG. 2 is an illustration of a car body part with indicia indicating damage parameters.

FIG. 3 is an illustration of an alternate embodiment of a scanner.

FIG. 4 is an illustration of alternate embodiment wherein the scanner is coupled to a rail.

FIG. 5 is an illustration of a deformed object.

FIG. 6 is an illustration showing laser lines projected onto the object.

FIG. 7 is an illustration of a user's head unit with built-in display, camera, earphone, and microphone.

FIG. 8 is an image of an assessor assessing the damage to a car.

FIG. 9 is an illustration depicting a list of vehicle identification information.

FIG. 10 is an image of a user reading a unique vehicle identifier from a vehicle.

FIG. 11 is an image of a graphical user interface displaying on the left hand side textual information which is linked to corresponding graphical information displayed on the right hand side.

### DETAILED DESCRIPTION OF THE PREFERRED EMBODIMENTS

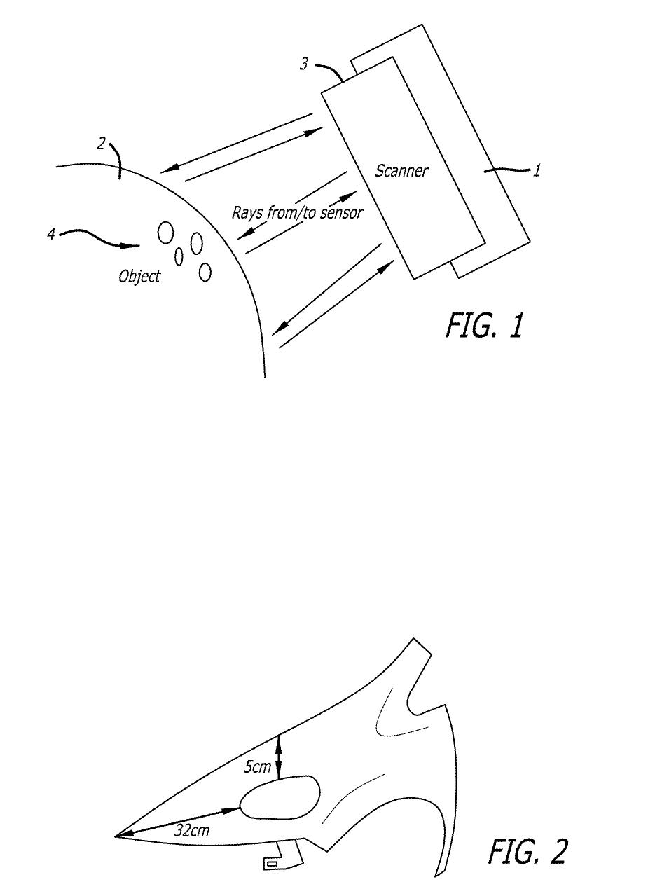

Referring to the drawings more particularly by reference numbers, FIG. 1 discloses a system for determining an estimate of damage to a vehicle. The system includes a computing device 1 that is utilized to determine damage to an object 2. By way of example, the computing device 1 may be a computing notebook, a computer system, a smart phone, a tablet PC, a pad computer, a digital camera, a TV, etc. The object may be, for example, a car, an automobile, a truck, a lorry, a motorbike, an airplane, a boat, or a ship.

The computing device 1 is coupled to a scanner 3 that scans the object 2 to determine damage 4. By way of example, the scanner 3 may be a hand-held or stationary device which projects rays onto to objects, collects the returning rays and processes the returning rays into data. The scanner 3 can be connected to the computing device 1 via cable or wireless connection. Damage may include dents, deformations, holes and scratches.

Typically, for car repair facilities, car insurance firms and damage appraisers, it is necessary to obtain an appraisal of the damage to a vehicle resulting from an incident. It is particularly important to determine efficiently and accurately an estimate of the damage, including the time and/or cost for repairing the damage to the car.

Typically damage on a vehicle is recorded by accessing the expertise of human beings (e.g. assessors) and entering the recognized damage into software on computing devices or onto paper.

The approach of this embodiment can eliminate opinions and allow accurate damage severity capturing based on digitally recorded facts.

In operation, the user swipes the scanner 3 over a damaged area of a vehicle 2 to collect 3-dimensional data. The collected data is processed by the computing device 1 to detect the damage of the scanned area of the vehicle.

The damage can be detected utilizing the following two methods:

a) Scanning 3D data from objects and processing the data with developed algorithms in order to detect damage

b) Scanning 3D data from objects and detecting the delta between the scanned 3D data and 3D reference data in order to detect damage

By way of example, damage detection method (a) can be used to detect to hail damage on a vehicle. The collected data that is generated by the scanner 3 is analyzed by the computing device 1 and automatically detects hail dents. Hail dents have specific characteristics, which can be detected with an algorithm performed by the device 1. The result of the hail damage detection may include a report that includes the following information:

Number of small dents

Number of medium dents

Number of large dents

Cost of labor time to repair the dents

By way of example, the damage detection method (b) may be utilized when damage cannot be detected by the algorithms described in method (a). The collected data which is generated by the scanner 3 is analyzed by the computing device 1 which automatically identifies the individual vehicle part and associated 3-D data. For example, the computing device 1 can determine that the part is a component of a left fender. The 3-D data of the left fender can be retrieved from a database. The computing device 1 internally projects the scanned 3D data of the identified parts over non-damaged reference data from the database. The computing device generates a delta between the scanned and database data and returns damage parameters according to defined damage attributes. An example of returned damage parameters is shown in FIG. 2, which provides the following information:

Part: Fender front left

Damage location: 32 cm from left, 5 cm from top

Damage area: 75 cm2

Damage severity depth): 3 cm

The result of the damage detection may be a report that contains the following information:

Cost of parts (if not repairable)

Cost of repair efforts if applicable

Cost of painting materials and effort

Cost of labor time

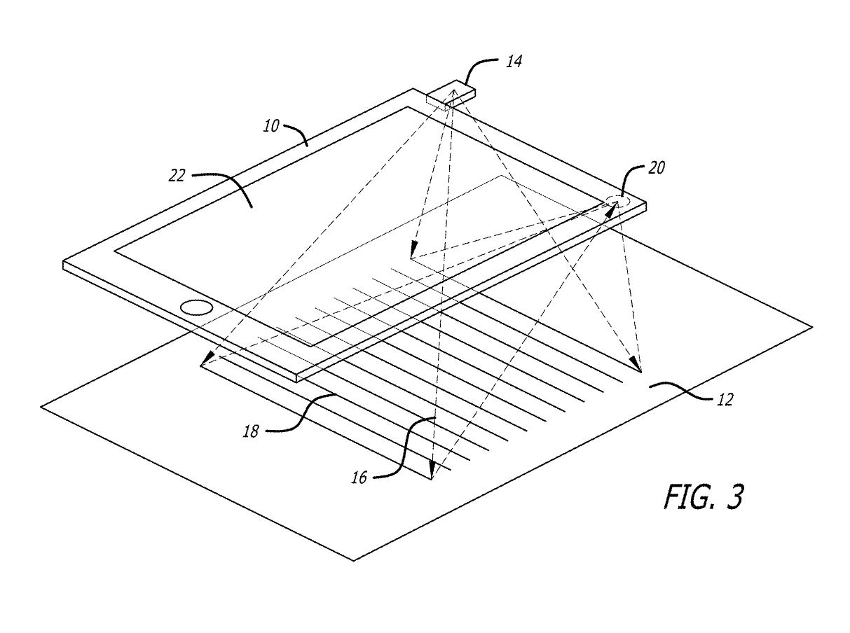

FIG. 3 shows another embodiment with a scanner device 10 that can be used to scan a damaged vehicle 12 to generate data that is used in an estimate. The scanner device 10 is preferably a mobile device such as a cell phone tablet or other hand held device. The device 10 includes a processor, memory and other electronic devices (not shown) as is known in the art. The scanner device 10 can be powered by battery (not shown) o connection to an outlet.

The device 10 may include a projector 14 that projects light that can be detected. By way of example, the projector 14 may emit a light beam 16, that may be laser or infrared light. The light may be emitted in parallel lines 18 or as a series of dots. By way of example, the projector 14 may be an electronic component that plugs into the electrical connector of a cell phone or tablet.

The device 10 includes a detector 20 that detects the emitted light beams 16. by way of example, the detector 20 may be a camera built into a cell phone or tablet. The device 10 may include a software application that processes the 3-D data to determine that shape and depth of any deformation in the vehicle surface. The shape and depth of deformation may be performed by a 3-D processing algorithm. Alternatively, the 3-D data may be compared with reference 3-D data to determine a delta between the two types of data. The processed 3-D data may be graphically displayed on a screen 22 of the device 10. The 3-D data may also be processed by an external device such as a personal computer.

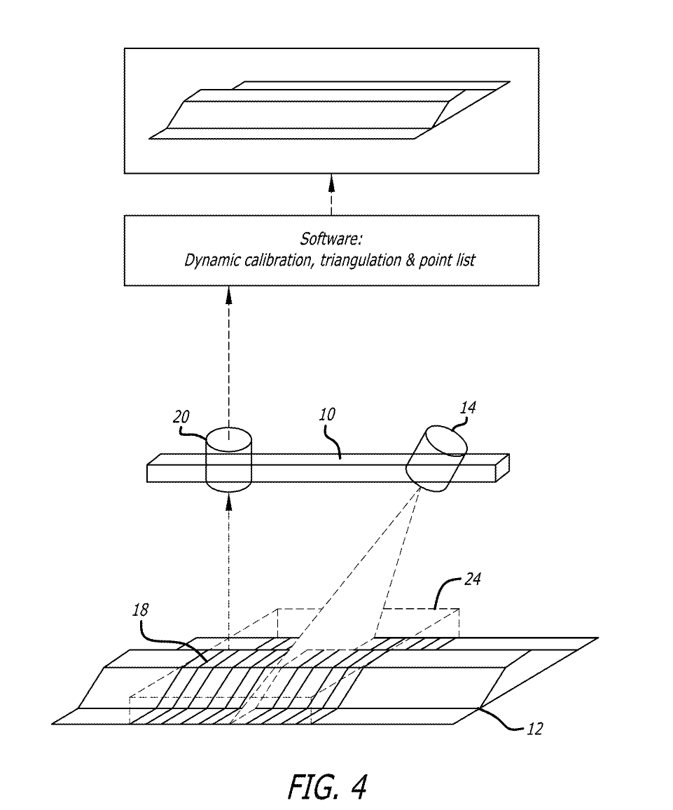

The 3-D data may be processed with a triangulation transformation technique. Processing with a triangulation technique requires a set-up calibration to define static relative positions between the light source 14, the object 12 to be scanned and the detector 20. The present invention allows for dynamic calibration. Referring to FIG. 4, the light source 14 and detector 20 are attached to a common rail (e.g. cell phone) so the distance between these components is known. A theoretical bounding box 24 is created around the object 12. Calibration can be achieved by analyzing the distance between the projected lines of light 18 and the bounding box 24 to simulate a static object distance. The transformed distance and angle parameters created during calibration can be used to form a classical reconstruction of the object using triangulation.

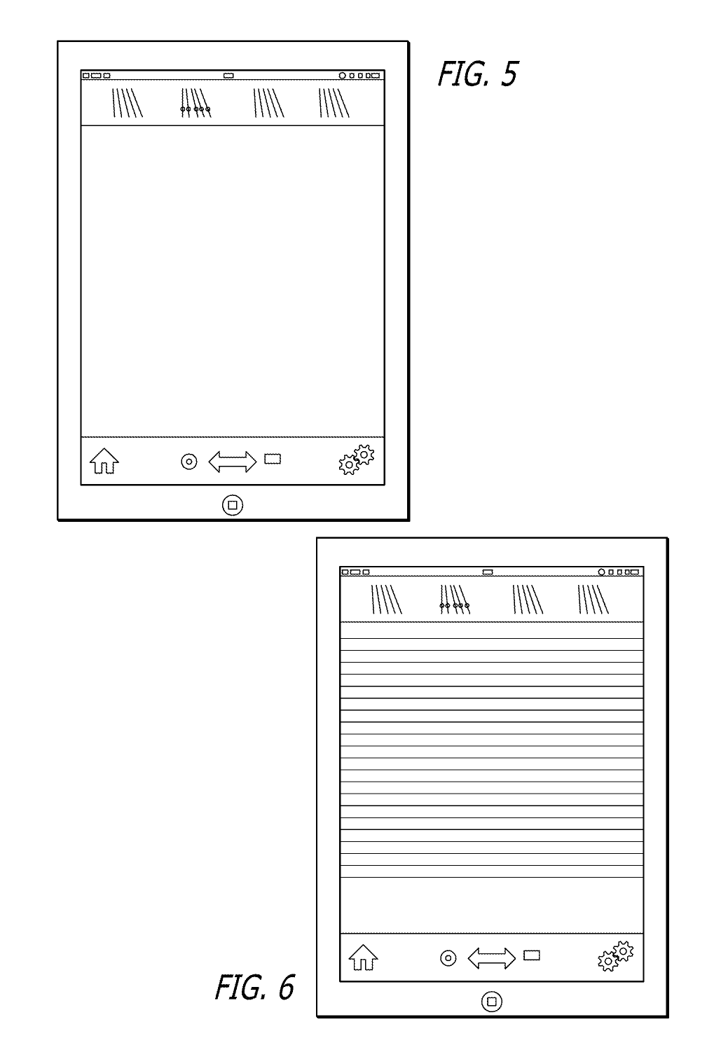

FIGS. 5 and 6 show an image of a deformation in an object and the projected laser lines on the object, respectively.

Another embodiment includes a system and method which assists the user through the process of vehicle service and/or parts replacement by visual overlays and audio instructions while viewing the physical vehicle. The system can provide artificial intelligence (AI), assuring that all required operations are completed before proceeding to the next step of the process. The quality of a remove and refit procedure can be confirmed by a software generated report.

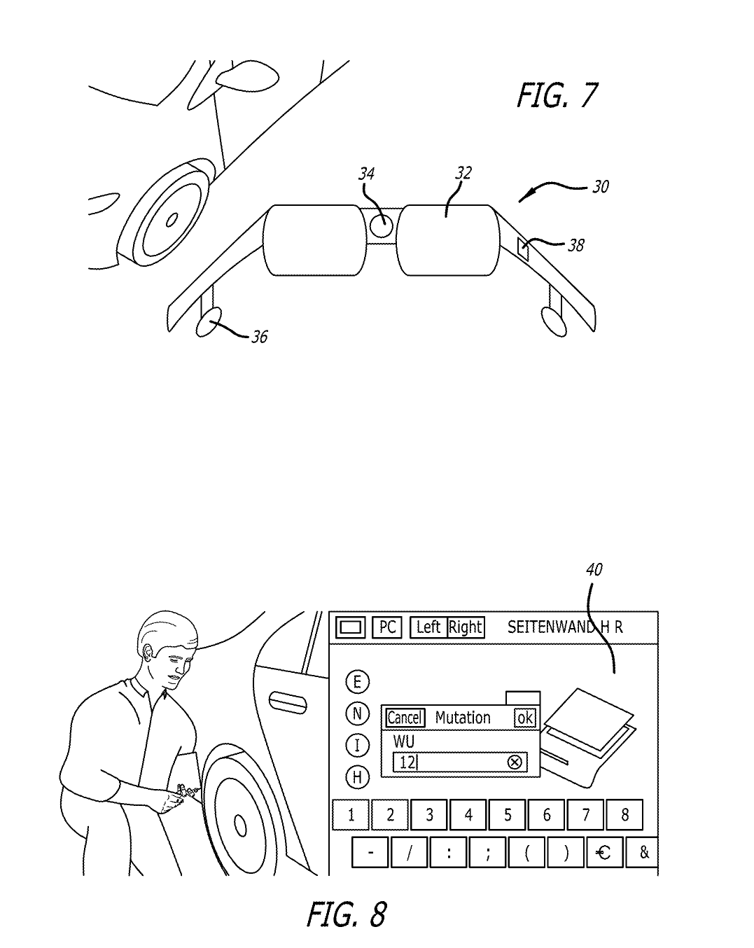

The system may include a head up display and an input device such as a tablet or laptop computer that can be utilized by a user to inspect a car and receive instructions on how to repair the car. FIG. 7 shows an embodiment of a head up display 30 that can be used to create a damage estimate for a damaged vehicle. The head up display 30 may include a display 32, a camera 34, speakers 36 and a microphone 38. FIG. 8 shows a user with a computing device 40 such as a tablet that can be used to enter data about a damaged vehicle.

Staffs of car repair facilities require vast amounts of training in order to learn processes required to service and repair vehicles. As vehicles become more and more sophisticated, extensive time is invested to research specific remove and refit procedures.

The complexity of vehicles often results in:

Incorrect removal of parts, leading to unnecessary damage.

Incorrect or incomplete reassembly of parts.

A following process can be implemented utilizing the head up display and computing device:

1. Prior to the remove and refit procedure, the user mounts the optical headset which interfaces via cable or wireless with the computing device.

2. The user verbally requests the desired vehicle and repair method from the software operating on the computing device.
a. The user can identify the vehicle by interacting with the software through verbal commands. The software can display a GUI on the display of the optical headset.
b. The vehicle can be identified by a VIN query result, allowing the user to directly select the required procedure.

3. The computing device initializes and the software informs the user via the headset overlay display that the procedure is ready to begin

4. The user stands in front of the section of the vehicle to which the procedure was selected.

5. The software analyses and detects the physical parts through the camera which is built into the optical headset.

6. The software overlays 3D graphics over the visible physical parts by projecting onto the optical headset.

7. The software indicates to the user that the procedure can begin, for example:
a. A “Ready to begin” message can be projected onto the headset.
b. An audio message “Ready to begin procedure” can be played through the earphones of the headset.

8. The user starts the procedure by speaking a start command like “Begin process”

9. The software guides the user with visual and audio instructions to execute the individual steps of the procedure. By way of example, when removing a wheel which is mounted on the car, the following steps may occur:
a. A nut on the wheel is highlighted with animated overlay 3D graphics, showing the user how to remove the nut (e.g. untighten anti-clockwise and remove from vehicle).
b. The system tracks the actions of the user by comparing the analyzed visual input through the headset camera with the data from the software database.
c. When the nut is removed, the user requests the software to proceed by speaking an instruction (e.g. “Next step”).
d. The AI of the software verifies that the nut was removed and proceeds to the next step.
e. The above procedure is repeated until the wheel has been removed from the vehicle.

10. To remount parts, the software guides the user with visual and audio instruction to execute the individual steps of the procedure, e.g., to refit the wheel on the vehicle:
a. The user instructs the software to launch the refit procedure for the wheel.
b. A reverse of the point (9) procedure is launched.
c. Each individual process step is monitored by the software, assuring that the step has been correctly executed by the user.
d. If the current step has not been correctly executed (e.g. nut not remounted), the software halts with a message (e.g. “Last operation not completed, please complete in order to proceed”).

11. When the refit procedure is completed, the software may generate a QA report, listing and confirming that all steps have been executed correctly.

The values and benefits of this process(es) include:

1. The time for training is strongly reduced as the user is being trained on the job.

2. The time required to remove and refit parts and/or aggregates on vehicles become more predictable.

3. Research prior to removing/refitting on unfamiliar vehicles is not necessary.

4. Vehicles leaving garages/workshops are safer due to the stringent process that ensures that all parts have been refitted onto the vehicle.

The head up display 30 can also be utilized to allow the user to provide input regarding the damaged vehicle through voice commands that are captured by the microphone 38 of the display unite 30.

In a vehicle damage claims process, it is often required to capture information under awkward circumstances. For example, the software user may be confronted with the following situations:

The damage can only be seen when kneeling down, looking into e.g. the wheel-arch of the vehicle.

The damage can only be seen when lying under the vehicle.

The vehicle is in a location with restricted possibilities to freely move (e.g. jammed between other vehicles).

Under difficult access circumstances, the user may not have the required computing device in near reach when viewing the damage. This may result in the capture of damage information without a direct view of the damage. This often leads to:

Over or underestimating of the damage.

Details are not considered.

Parts of the damage capturing is based on assumptions.

Utilizing the head up display 30 a user of the vehicle damage claims process can reliably capture information under inconvenient spatial circumstances using intelligent voice control with natural speech, while having the damage in sight, there is no necessity for a keyboard.

The user can formulate the damage in

his/her own vocabulary. For example:

Select front fender right

Select wing front right

Select front right wing

The following process may occur when utilizing the display unit to provide voice commands for a damage estimate:

1. The user launches a software application;

2. The user mounts an audio or optical headset which is wirelessly interfaced to the computing device

3. The user speaks the instruction which are to be recorded by the software, e.g.:

a. Replace front right fender.

b. Paint front right fender.

c. 1 hour to repair front right door.

d. Repaint the front right door.

4. As the user speaks the instructions, the solution immediately executes the operating commands in the launched software application (e.g. damage capturing application).

5. The voice control is closed/ended when the user speaks a uniquely defined set of words (e.g. “end, end, end control”)

If it is necessary to monitor in real time what information the executing application is capturing, the system is operated with an optical headset.

The values and benefits of this embodiment include:

1. High time saving due to less time spent to move between a computing device, such as a laptop, and the damaged vehicle.

2. More accurate damage estimations as the damage is being described while in sight

3. Computing devices can be operated in a hands free mode, allowing capturing information when the user is for example inspecting the damage while lying under the vehicle

Another embodiment includes a system and method for storing and retrieving a unique identification tag for a vehicle using optical and/or sensor based tags. The unique number is retrieved by use of a computing device and when retrieved displays the full identification information of the vehicle.

When buying, selling or repairing a vehicle, it is often difficult to obtain fully detailed information about the vehicle and the options with which it is equipped. Buyers of used vehicles don't know if the vehicle is equipped with the original options as delivered by the factory. Sellers of used vehicles often don't know which options are equipped with the vehicle. Mechanical and body repair shops have difficulties detecting and ordering the right parts for repairs as these often differ depending on the identification/options of the vehicle.

In accordance with this embodiment, a vehicle is equipped with a tag containing a unique vehicle identifier, e.g. a number or code. For example, this number is stored in one of the following manners:

RFID system (Radio Frequency Identification), which has the advantage that the unique vehicle identifier does not have to be within line of sight of the reader and can be embedded/hidden in the vehicle.

QR-Code (Quick Response Code), which has the disadvantage that the unique vehicle identifier needs to be within direct line of sight of the reader.

The unique vehicle number is retrieved using a computing device. A software service is accessed and delivers back the full identification of the vehicle. The full identification may include the following vehicle information:

Vehicle manufacturer.

Manufacturer model.

Engine.

Transmission.

Vehicle body style.

Number of doors.

A list of each individual option with which the vehicle was equipped when leaving the factory may include:

New vehicle price.

Price of each individual option.

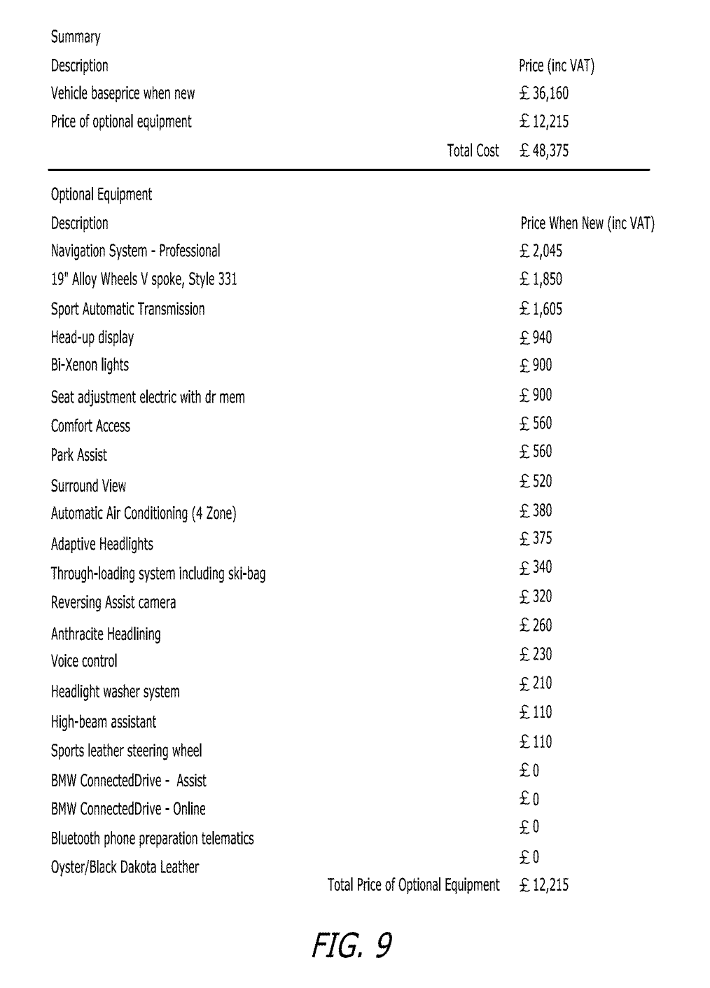

An exemplary list of vehicle information is shown in FIG. 9.

The unique vehicle identifier can be read from the vehicle with various methods including but not limited to:

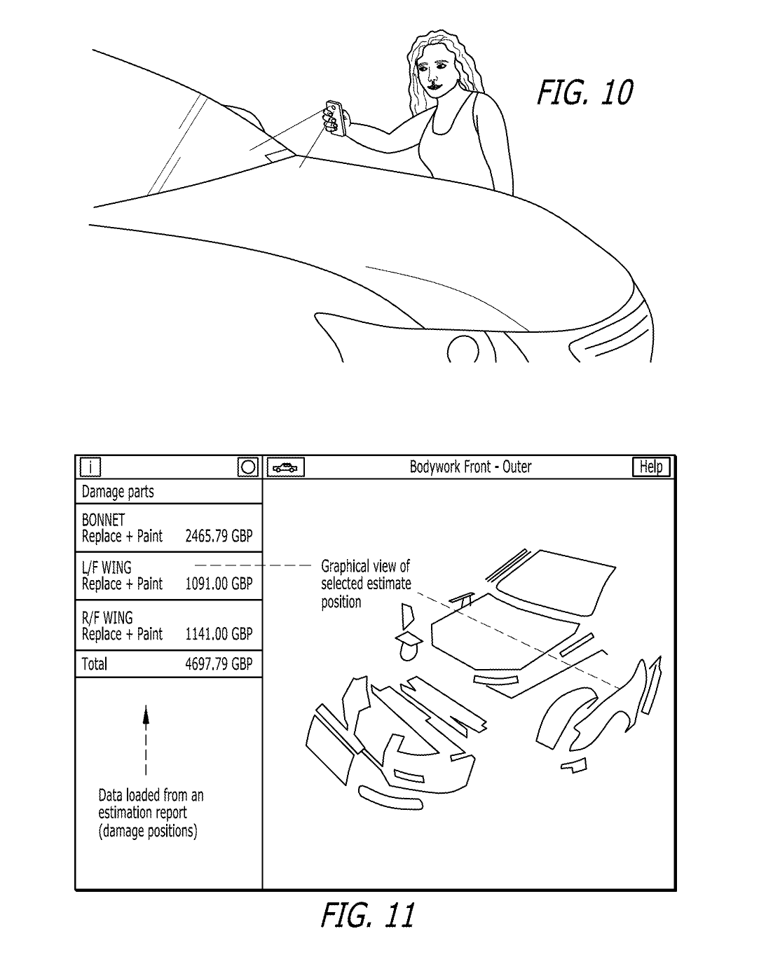

Photographically from a computing device with line of sight to the code tag as shown in FIG. 10.

From a sensor reader connected to a computing device, either wired or wirelessly. The user can be anywhere near the vehicle in order to retrieve the code.

The values and benefits of this embodiment include instant, reliable detection of the vehicle identification and options for consumers and commercial organizations, used for:

Selling information's of a used vehicle.

Information's for buyers of used vehicles.

Information's for mechanical and body repair shops, allows ordering the correct parts and reduces returns to suppliers.

Model selection for vehicle damage capturing.

Model selection for vehicle valuation.

Another embodiment includes a system and a method for reviewing invoices and bids with side by side viewing of items displayed in textual and graphical form. Textual data can be processed and shown in graphical form as shown in FIG. 11. Processing may include providing a relational database and matching textual descriptions with graphical images. The graphical view can be zoomed and rotated by applying common usage gestures (e.g. pinch for zoom, swipe for rotate). A selected active graphical part can be isolated from the rest of the graphical parts for detailed investigation and reviewing.

The values and benefits of this embodiment include:

Large time savings as the user simply scrolls through the textual damage positions and instantly sees the graphical representation of the actively selected item.

Higher review quality, as the textual data is not interpreted by the user, the data can be recognized by a clear and understandable graphical representation.

Possible to review data from sources that the reviewer is not familiar with.

What is claimed is:

1. A system that determines an estimate of damage to a surface area of a vehicle, comprising:
a scanner that generates scanning data representative of a surface area of the vehicle; and,
a computing device that processes said scanning data to detect damage items and generates an estimate of damage using said processed scanning data.

2. The system of claim 1, wherein said computing device process the scanning data to detect dents in the surface area, to assess a size and number of the dents, and to generate the estimate of damage using the size and number of the dents.

3. The system of claim 1, wherein said computing device performs a comparison of said scanning data to stored reference data, and detects the damage items based on the comparison.

4. The system of claim 1, wherein said scanner is an integral component of said computing device.

5. A method for determining an estimate of damage to a surface area of a vehicle, comprising:
scanning the surface area of the vehicle with a scanner and generating scanning data;
transmitting the scanning data to a computing device;
processing in the computing device the scanning data to detect damage items; and
generating in the computing device an estimate of damage using the damage items detected.

6. A non-transitory computer program storage medium, comprising:
a non-transitory computer program storage medium that contains a computer program that causes a computing device to receive from a scanner scanning data representative of a surface area of the vehicle, process the scanning data to detect damage items, and generate an estimate of damage using the damage items detected.

7. A system for assisting a user in a repair of car damage comprising a user head set with a microphone that can capture user instruction defining a car model and a repair method and a display that displays repair instruction for repairing the vehicle;
a computing device coupled to said user head set that receive the user instructions and provides the repair instructions.
receive from a video sensor installed on a user headset video data of car parts observed by the user; and
transmit to a display of the headset instructions for performing the repair.

8. A computer-implemented method of assisting a user in a repair of car damage, the method comprising receiving in the computer from the user instructions defining a car model and a repair method.

9. A computer program product comprising a tangible computer-readable medium having stored thereon computer program code configured to direct a computing system to:
receive from the user instructions defining a car model and a repair method;
receive from a video sensor installed on a user headset video data of car parts observed by the user; and
transmit to a display of the headset instructions for performing the repair.

10. A computing device for assisting a user in estimating damage to a vehicle, the computing device comprising one or more processors configured to:
receive via a headset of the user voice commands from the user;
process the voice commands of the user for identifying car parts and repair operations; and
generate the estimate of damage using the car parts and repair operations identified.

11. A computer-implemented method of assisting in estimating damage to a vehicle, the method comprising:
receiving in the computer via a headset of the user voice commands from the user;
processing in the computer the voice commands of the user for identifying car parts and repair operations; and
generating by the computer the estimate of damage using the car parts and repair operations identified.

12. A computer program product comprising a tangible computer-readable medium having stored thereon computer program code configured to direct a computing device to:
receive via a headset of the user voice commands from the user;
process the voice commands of the user for identifying car parts and repair operations; and
generate the estimate of damage using the car parts and repair operations identified.

13. A computing device for determining vehicle information associated with a specific vehicle, the computing device comprising one or more processors configured to:
read from the vehicle a unique vehicle identifier;
query a vehicle database for the vehicle information using the vehicle identifier; and
show on a display the vehicle information queried from the vehicle database.

14. A computer-implemented method of determining vehicle information associated with a specific vehicle, the method comprising:
reading by a computing device from the vehicle a unique vehicle identifier;
query by the computing device a vehicle database for the vehicle information using the vehicle identifier; and
showing by the computing device on a display the vehicle information queried from the vehicle database.

15. A computer program product comprising a tangible computer-readable medium having stored thereon computer program code configured to direct a computing device to:
read from the vehicle a unique vehicle identifier;
query a vehicle database for the vehicle information using the vehicle identifier; and
show on a display the vehicle information queried from the vehicle database.

16. A computing device for presenting to a user information about vehicle components, the computing device comprising one or more processors configured to:
receive from the user a selection of textual information related to the vehicle components;
query a vehicle component database for graphical vehicle component information linked to the textual information; and
show on a display the graphical vehicle component information linked to the textual information.

17. A computer-implemented method of presenting to a user information about vehicle components, the method comprising:
receiving in the computer from the user a selection of textual information related to the vehicle components;
querying by the computer a vehicle component database for graphical vehicle component information linked to the textual information; and
showing by the computer on a display the graphical vehicle component information linked to the textual information.

18. A computer program product comprising a tangible computer-readable medium having stored thereon computer program code configured to direct a computing device to:
receive from the user a selection of textual information related to the vehicle components;
query a vehicle component database for graphical vehicle component information linked to the textual information; and
show on a display the graphical vehicle component information linked to the textual information.
